(19) United States
(12) Patent Application Publication
(10) Pub. No.: US 2002/0107733 A1
(43) Pub. Date: Aug. 8, 2002

(54) Method for promoting products using a world wide web

(76) Inventors: Wanqian D. Liu, Fremont, CA (US); Song Li, Campbell, CA (US); Robert J. Zhang, San Mateo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/834,855

(22) Filed: Apr. 12, 2001

Related U.S. Application Data
(60) Provisional application No. 60/220,548, filed on Jul. 25, 2000.
(60) Provisional application No. 60/220,551, filed on Jul. 25, 2000.

(51) Int. Cl. G06F 17/60

(52) U.S. Cl. 705/14

(57) ABSTRACT

A method for promoting products with a central server over a computer network includes receiving a specification of a promotion for a product from a first computer, creating an electronic incentive in response to the specification, transferring the electronic incentive to an application server across the computer network, the application server coupled to a merchant server, receiving usage data of the electronic incentive from the application server, the usage data determined in response to a promotion usage condition indicated by the merchant server, and generating a report in response to the usage data, wherein data associated with the electronic incentive is transferred from the application server to the merchant server, wherein the merchant server specifies rendering of the data associated with the electronic incentive, and wherein the promotion usage condition is indicated in the merchant server when a user coupled thereto fulfills requirements of the electronic incentive.

### CROSS-REFERENCES TO RELATED APPLICATIONS

This application claims priority to Provisional Application No. 60/220548 filed Jul. 25, 2000, provisional Application No. 60/220551 filed Jul. 25, 2000, and provisional Application No. 60/226483 filed Aug. 18, 2000. These applications are hereby incorporated by reference for all purposes. This application also incorporates the following reference for all purposes: co-pending application number ______, filed ______, Attorney Docket No 020683-000120US titled System For Promoting Products Using A World Wide Web.

### BACKGROUND OF THE INVENTION

The present invention relates to methods and systems for creating and distributing promotions across a computer network. Further, the present invention relates to methods and systems for using promotions and for monitoring promotions across a computer network.

Under economic theory, the law of supply and demand suggests that an equilibrium between the number of goods produced and a product price can be reached in the free market. However, not content with profits at such equilibriums, marketers and promoters have tried to find ways to attract buyers who would not have purchased the product at the equilibrium price. Such buyers may be termed “target buyers.” One conventional way to attract target buyers has been through the use of traditional paper-based coupons.

As is well known, coupons are detachable, possessable certificates that possess a monetary value. For example, typical coupons may be worth 1/10¢, 1/20¢, or the like. The real “worth” of traditional coupons are that they provide the bearer or presenter with proof of the right to exercise a predetermined bargain. For example, it allows the bearer to “save $1” off the price of a CD; it allows the bearer to “get one free” with purchase of “one;” and the like. Traditionally, marketers/promoters of products provide consumers with coupons to attract purchasers who otherwise would not have considered purchasing the product, i.e. target buyers.

A problem with traditional coupons includes that coupons often end up in the hands of buyers who are not targeted. This is because distributing coupons only to target buyers is virtually impossible. Although some coupons may be distributed to channels such as magazines, direct mailings, and the like that include a large percentage of target buyers, a significant percentage nevertheless reaches non-target buyers. These non-target buyers may include those willing to purchase the product even without the coupon. Accordingly, if non-target buyers uses the coupons to purchase a product, this directly reduces the amount of profit to the promoter. As an example, a promoter may create a promotion directed to Pepsi™ drinkers to try Coke™. To do so, the promoter offers coupons providing the bearer with a dollar off a six-pack of Coke™. However, it is virtually impossible to prevent a devoted Coke™ drinker from picking and redeem that coupon. This sort of common situation directly “siphons-off” manufacturer profits.

Thus, in light of the above, what is needed in the industry are improved methods and apparatus for providing targeted promotions to users while reducing the drawbacks discussed above.

### SUMMARY OF THE INVENTION

The present invention relates to methods and systems for creating promotions and distributing promotions across a computer network. Further, the present invention relates to methods and systems for providing promotions and for monitoring promotions across a computer network.

In one embodiment, as on-line consumers browse through the aisles of an online store and decide what to put in their shopping cart, the system described below allows marketers to communicate with the consumers and impact their buying decisions. In particular, embodiments of the present invention provide help marketers offer various real-time promotions based on special targeting criteria. Accordingly, marketers can convey a variety of messages to a variety of target consumers at critical moments when the consumer is making choices. Such promotions benefit consumers, who receive valuable personalized content, and benefit online retailers or the like, who experience increased sales and site-loyalty.

Embodiments of the present invention deliver real-time promotions. The assignee of the present invention provides Electronic Consumer Incentives™ (ECI™) brand real-time promotions to on-line customers as they shop. The real-time promotions are dynamically displayed on consumers' computer screens in an unobtrusive manner as consumers navigate though online stores making purchase decisions. Different real-time promotions are viewed by each consumer, depending on how consumers fit promotion targeting criteria specified by the promoter (marketers). In some embodiments, as a consumer places an item in her shopping cart or navigates to a different “aisle” or category in an on-line store, different real-time promotions will appear on her computer screen. One embodiment of this real-time promotion is implemented using products and services available from the current assignee including: InformLink's Web Portal and InformLink.Net.

According to one aspect of the invention, a method for promoting products with a central server over a computer network is disclosed. The method may include receiving a specification of a promotion for a product from a first computer, creating an electronic incentive in response to the specification, and transferring the electronic incentive to an application server across the computer network, the application server coupled to a merchant server. In some techniques, the method also includes receiving usage data of the electronic incentive from the application server, the usage data determined in response to a promotion usage condition indicated by the merchant server, and generating a report in response to the usage data. In some cases, data associated with the electronic incentive is transferred from the application server to the merchant server, the merchant server specifies rendering of the data associated with the electronic incentive, and the promotion usage condition is indicated in the merchant server when a user coupled thereto fulfills requirements of the electronic incentive.

According to another aspect of the invention, a method for a merchant server coupled to a client system is disclosed. The method may include requesting promotions from an application server coupled to the merchant server, receiving a description of a promotion from the application server, the description including pre-conditions and a user benefit, determining an output representation of the promotion in response to the description of the promotion, and transmitting the output representation of the description to a client system for display to a user. The method may also include receiving a selection of at least one item from the client system, and transmitting the selection of the at least one item to the application server. When the application server determines that the selection of the at least one item fulfills the pre-conditions, an indication that the user is provided with the user benefit from the application server is received. The technique may also include storing in a log a record that the user is provided with the user benefit.

According to yet another aspect of the invention, a method for an application server is disclosed. The method may include receiving an electronic incentive from a central server, the electronic incentive including a pre-condition and a benefit, receiving a request from a merchant server for electronic incentives, and providing a description of the electronic incentive to the merchant server in response to the request, the description including a description of the pre-condition and the benefit. The technique may also include receiving from the merchant server a selection by a user of at least one item, and determining whether the selection of the one item fulfills the pre-condition. When the selection of the one item fulfills the pre-condition, the merchant server is provided with the benefit. Further, when the selection of the one item fulfills the pre-condition, usage of the electronic incentive is logged.

### BRIEF DESCRIPTION OF THE DRAWINGS

In order to more fully understand the present invention, reference is made to the accompanying drawings. Understanding that these drawings are not to be considered limitations in the scope of the invention, the presently preferred embodiments and the presently understood best mode of the invention are described with additional detail through use of the accompanying drawings in which:

FIG. 1 illustrates a block diagram according to an embodiment of the present invention;

FIG. 2 is a block diagram of typical computer system 200 according to embodiments of the present invention;

FIG. 3 illustrates a block diagram according to an embodiment of the present invention; and

FIGS. 4A-D illustrate a block diagram of a flow chart according to an embodiment of the present invention.

### DESCRIPTION OF THE SPECIFIC EMBODIMENTS

The following terms are used in the present application:

Brand—A specific group of related products.

Category—Hierarchical product association, (e.g. Disposal Diapers).

Category ID/Listing—A number assigned to a category.

Cents Off—Cents off promotions are used for giving a specific dollar amount of a product or groups of products. Example: Buy any widget get $0.50 off or buy any widget and any trinket save $1.00. More generally, such promotions describe an amount of monetary savings available.

Creation Date—The date the promotion was created.

Cycle—A defined period of time that a promotion can run. In one embodiment, there are 13 cycles a year and manufacturers/promoters have the ability to run promotions in a certain category per cycle.

Description—Description for the promotion. Example: Any 12-oz. Soft Drink.

Display Types—A display type is selected when the promoter determines how a promotion should be displayed on a customer display. Display types include static and trigger. A static display is delivered in a specific aisle of the store. A triggered display is delivered from a current shopping pattern of a customer or based upon items within a current customer cart.

Division—Hierarchical reporting level inside a Company that is used for grouping brands together.

Effective Date—The date the promotion begins.

Expiration Date—The date the promotion ends.

Free Value—Free Value is used for running a ‘Buy X, Get Y Free” promotion, or for giving away a free sample. Example: Buy one widget get one free, buy widget A get widget B free.

UPID—UPID (uniform product identification) is selected from a list or entered manually)—An invoice number that is used by the central data server to track promotions created by marketers (promoters).

Name—The Brand Manager's, Promoter's, Manufacturer's name.

Offer Description—A description of the promotion/offer.

Offer Setup—Detailed rules the promoter enters to define the offer.

Offer Tracking Code—A unique number assigned by the Brand Manager or Retailer. This code becomes the permanent identifying number that is used for all future queries, tracking and reporting. In one embodiment the field can be 10 characters.

Offer Type—An offer type is the type of offer the product wants to execute.

Participating Retailers—Retailers or Merchants that will display the promotion.

Price Point—Price Points are used to promote an item or items at a certain price. Example: Buy any widget for $2.99.

Product UPC—A universal product code that uniquely identifies and defines each product.

Program Manager—A Program Number is used to group a set of promotions together. An example would be a campaign using multiple promotions for a common theme. The program number allows the promoter to receive reports of all promotion activity for a campaign under a master number.

Promotional Content—Used for displaying recipes or product information. This can be used alone or in conjunction with another offer type. Embodiments require a link to a URL that will contain the text copy, however content may also be maintained locally.

Restriction—Limitations of the promotion. Example: Limit one per customer.

Title—Title or name of the promotion. Example: Save $2.00.

Promotional Content URL—Retailer's website address.

User ID—An ID that identifies the user (e.g. brand manager/promoter, retailer/merchant).

User Name—Name of the assigned user, brand manager or retailer.

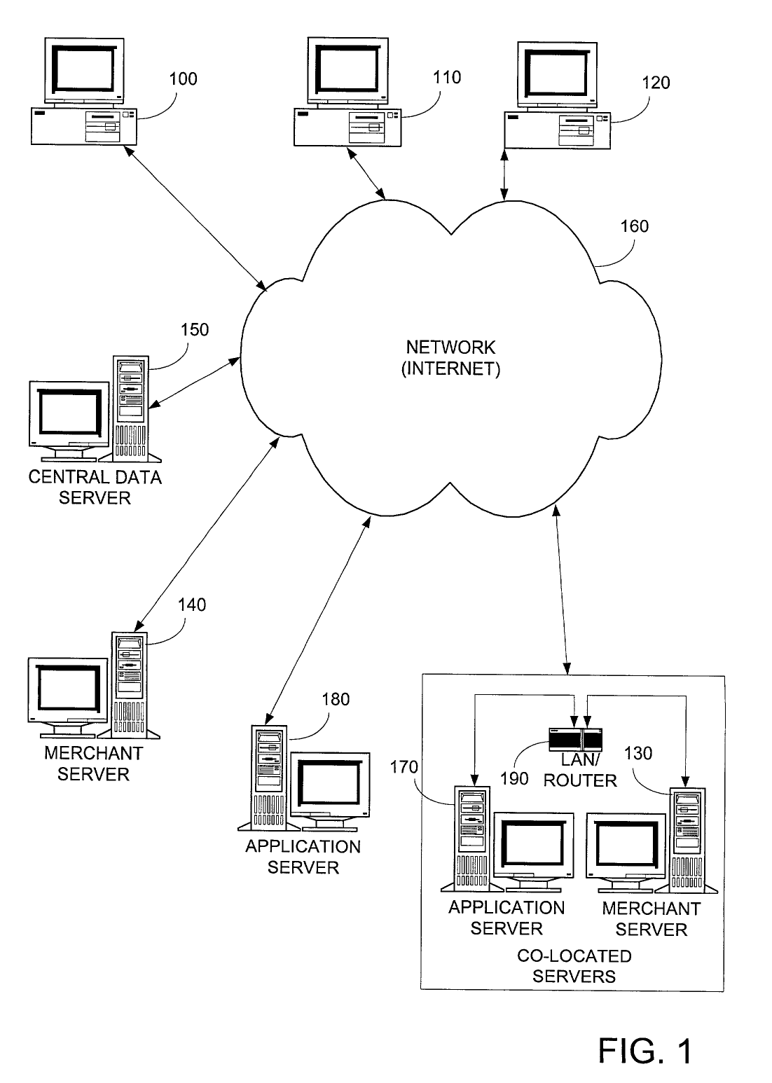

FIG. 1 illustrates a block diagram according to an embodiment of the present invention. FIG. 1 illustrates a promoter system 100, client systems 110 and 120, merchant servers 130 and 140, and a central data server 150 coupled to a computer network 160. Merchant server 130 is coupled to an application server 170, and Merchant server 140 is coupled to an application server 180.

In the present embodiment, promoter system 100 and client systems 110-120 are standard personal computers used by business, individuals, and the like. Client systems 110-120 are used by users to communicate with merchant servers 130 and/or 140. In the present example, promoter system 100 and client systems 110-120 typically use web browser programs, and other software, as will be described further below.

Promoter system 100 and client systems 110-120 are typically connected to computer network 160 via dial-up, ISDN, DSL, cable, satellite modems or the like, via wireless network interface hardware, or the like. Merchant servers 130 and 140, and data server 150 are typically connected to computer network 160 through high bandwidth channels, such as T1 or T3. Further, local area networks and routers (LANs) may also be used by client systems 100-120, merchant servers 130 and 140 and/or data server 150.

In this example, merchant servers 130 and 140 are typically web servers and/or gateway servers. Such servers may or may not be physically resident on the merchants property. As web servers, merchant servers 130 and 140 are typically used to host the merchant's web site including storage of web pages, a database, and the like.

Coupled to merchant servers 130 and 140 are application servers 170 and 180, respectively. In one embodiment, application server 170 is coupled to merchant server 130 via a LAN 190, or the like. In such an embodiment, application server 170 and merchant server 130 may be co-located at the same server facility. Advantages to co-location include that communication between merchant server 130 and application server 170 is enhanced and server response latencies are greatly reduced.

In another embodiment, application server 180 is coupled to merchant server 140 via computer network 160. In this embodiment, communication between these servers may be via a virtual private network (VPN), or other secure protocol, such as an SSL or SHTTP. In still other embodiments, application server 180 may provide services to more than one merchant server. For example, application server 180 may provide services to merchant server 140, to merchant server 130 as a back-up for application server 170, and for other merchant servers that do not have a co-located application server.

Promoter system 100 is typically coupled to data server 150 via computer network 160. In other embodiments, other types of communications channels may be used, such as direct dial-up, or the like. In this embodiment, promoter system 100 is used by a user to specify parameters of a real-time promotion (or electronic incentive) to be stored and implemented in data server 150, as will be described further below. In the present embodiment, data server 150 may include a web server application that communicates with promoter system 100.

In the present embodiment, data server 150 provides promotion data to application servers 170 and 180 via computer network 160. Additionally, data server 150 receives return data from application servers 170 and 180 via computer network 160. More specifically, as will be discussed below, data server 150 “packages” the real-time promotion parameters received from promoter system 100 and provides promotion data to application servers 170 and 180. In return, application servers 170 and 180 provide promotion usage data back to data server 150. In other embodiments, other forms of communications channels may be used between the servers 150, 170, and 180, such as direct dial-up connections, rf, satellite, and other wireless communications schemes, and the like.

Computer network 160 is typically a wide area network (WAN) such as the Internet, or the like. In this embodiment, computer network 160 may use communication protocols such as TCP/IP, RTP, RTSP, or the like for the transfer of data. In other embodiments, computer network 160 may be a local area network (LAN), based upon TCP/IP, IPX, or the like. As mentioned above, computer network 160 provides data communication among systems 100-120, servers 130-140, 170, and 180, and other computer servers and systems. Data communication may include transfer of HTML based data, textual data, form submissions, plug-in programs or viewers, applets, packetized audio or video data, real-time streaming data, and the like. Although computer network 160 is illustrated as a single entity, as is the case with the Internet, it should be understood that computer network 160 may actually be a network of individual computers and servers.

The diagram in FIG. 1 is merely an illustration which should not limit the scope of the claims herein. One of ordinary skill in the art would recognize many other variations, modifications, and alternatives.

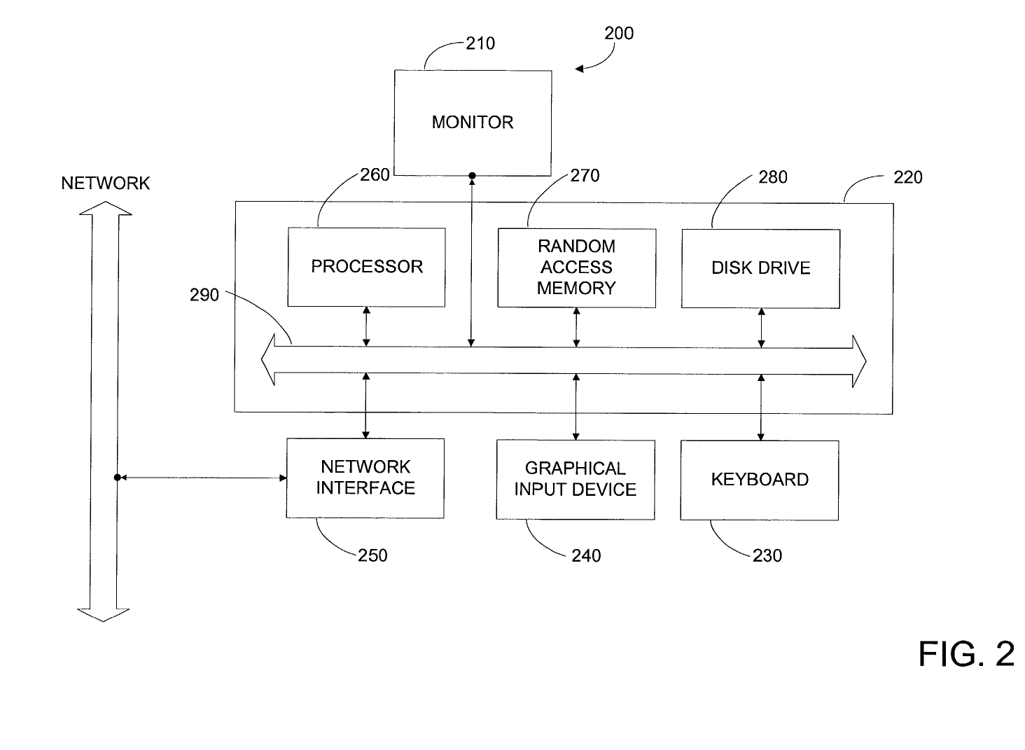

FIG. 2 is a block diagram of typical computer system 200 according to embodiments of the present invention. Embodiments of systems 100-120 and servers 130-140, 170, and 180, may be embodied as computer system 200.

In the present embodiment, computer system 200 typically includes a monitor 210, computer 220, a keyboard 230, a user input device 240, a network interface 250, and the like.

In the present embodiment, user input device 240 is typically embodied as a computer mouse, a trackball, a track pad, wireless remote, and the like. User input device 240 typically allows a user to select objects, icons, text and the like that appear on the monitor 210.

Embodiments of network interface 250 typically include an Ethernet card, a modem (telephone, satellite, cable, ISDN), (asynchronous) digital subscriber line (DSL) unit, and the like. Network interface 250 are typically coupled to a computer network as shown. In other embodiments, network interface 250 may be physically integrated on the motherboard of computer 220, may be a software program, such as soft DSL, or the like.

Computer 220 typically includes familiar computer components such as a processor 260, and memory storage devices, such as a random access memory (RAM) 270, disk drives 280, and system bus 290 interconnecting the above components.

In one embodiment, computer 220 is a PC compatible computer having an x86 based microprocessor, such as an Athlon™ microprocessor from Advanced Micro Devices, Inc. Further, in the present embodiment, computer 220 typically includes a Windows™ operating system such as Windows ME, WindowsNT, or the like from Microsoft Corporation.

RAM 270 and disk drive 280 are examples of tangible media for storage of data, audio/video files, computer programs, browser software, embodiments of the herein described invention, applet interpreters or compilers, virtual machines, web pages, databases such as Oracle 8i, and the like. Other types of tangible media include floppy disks, removable hard disks, optical storage media such as CD-ROMS and bar codes, semiconductor memories such as flash memories, read-only-memories (ROMS), battery-backed volatile memories, and the like. In embodiments of the present invention, such as set top boxes, mass storage, such as disk drive 280, and the like may be dispensed with.

In the present embodiment, computer system 200 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 2 is representative of types of computer systems for embodying the present invention. It will be readily apparent to one of ordinary skill in the art that many other hardware and software configurations are suitable for use with the present invention. For example, other types of processors are contemplated, such as Pentium™ class, Celeron™-class, or other microprocessors from Intel Corporation; PowerPC G3™, G4™ microprocessors from Motorola, Inc.; Crusoe™ microprocessors from Transmeta, and the like. Further, other types of operating systems are contemplated, such as Solaris, LINUX, UNIX, MAC OS from Apple Computer Corporation, BeOS, and the like. Additionally the specific configuration of the hardware and software will vary when computer system 200 is configured as client system 110, as promotion server 150, or the like. In still other embodiments, set top boxes such as the PS2, X-Box, WebTV, and the like may also be used.

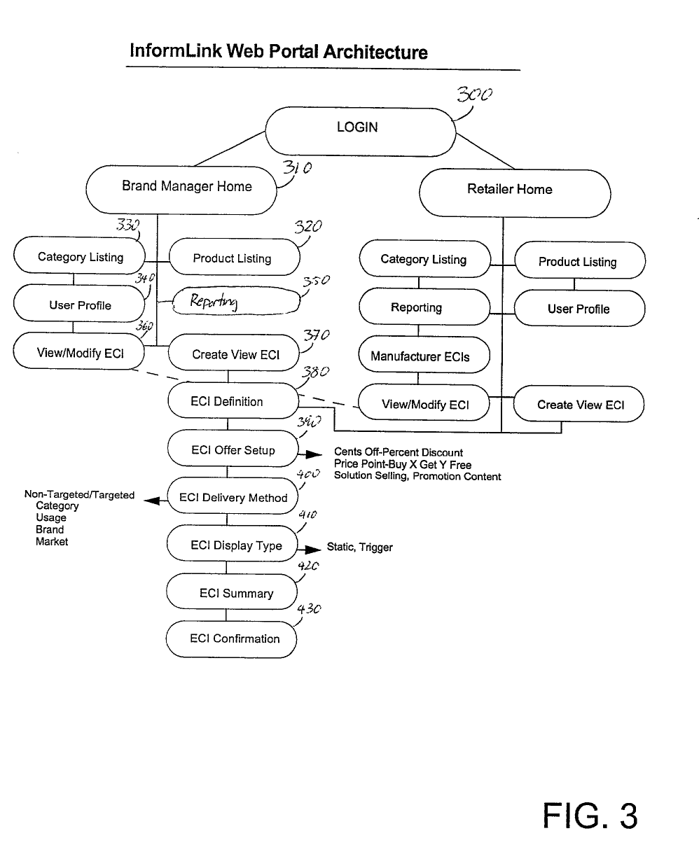

FIG. 3 illustrates a block diagram according to an embodiment of the present invention. In particular, FIG. 3 illustrates the logical software architecture of centralized data server 150. In this embodiment, users (promoters) at promotion servers 100 and users (merchants) at merchant servers 130 can specify and/or view real-time promotions and data related to promotions.

In FIG. 3, a login process 300 is provided that authenticates and verifies the user. In this case, promoters and merchants are typically pre-assigned accounts with data server 150 after agreeing to the real-time promotion service. In other embodiments, such users can sign-up on-line.

When the user is identified as a promoter, the user is directed to the brand manager home 310. From there, the promoter is given a variety of options. For example, the promoter can define and view products available for promotional activity with a product listing process 320. The promoter can also define and view categories of product available for promotional activity with a category listing process 330. In process 340, the user can define and change the promoter profile, for example, brand manager name, contact information, and the like.

In reporting process 350, the promoter can review report data. In one embodiment, the report data includes which promotions were used by consumers, the demographics of the consumer, the number of promotion impressions, the items purchased, or the like along with the promotion, and the like. In additional embodiments, other types of data that may be provided include the amount of promotion provided, category views, trigger views, and the like, as will be described further below. Such data is useful to the promoter in determining the success of different promotions, different promotion strategies, the success of promotion targeting, and the like.

Process 360 allows the promoter to view and modify the various parameters of promotions that are created in processes 370-420.

In the present embodiment, processes 370 and 380 allow the promoter to create and define a promotion. Process 380 includes sub-processes 390-430. In the present embodiment, sub-process 380 allows the promoter to setup administrative details of the promotion. In this example, the promoter may specify an offer tracking code, a program number for the promotion (e.g. to identify a “back to school” promotional campaign), a timing cycle, and merchants or retailers that will participate in the promotion. In other embodiments, additional administrative details may be specified including a phenotype of the promotion, a description of the promotion, promotional limitations, effective date, expiration date, a URL including additional promotional content (e.g. a web-site including recipes), and the like.

In this embodiment, sub-process 390 allows the promoter to specify the actual promotion. The promotion typically includes an offer type, a product bundle, and an amount. In this example, typical offer types includes cents off, percent discount, price point, buy X get Y free, free value (e.g. product samples), additional promotional content, and the like.

A product bundle typically refers to products that must be purchased together in order to trigger the promotion. For example, a bundle may include purchase of ketchup, mustard, and relish. In this embodiment, the product bundle may include up to three products, although in other embodiments, a greater number of products may be bundled.

In this example, the number of times a specific promotion may be used can be specified by the promoter. For example, the maximum number of promotion uses may be limited by the total number per merchant/retailer, the total number for the promotional campaign, and/or the number of promotion uses per shopping trip (e.g. one per visit). Additionally, the maximum number of dollars used in the campaign may be specified, and the like. These limitations to the number of times a promotion may be used may be specified for each of the offer types discussed above.

In this embodiment, sub-process 400 allows the promoter to specify a delivery method for the promotion. In particular, this process allows the promoter to target the promotion. In this example, four types of targeting methods are provided: category, usage, brand, and market. Category targeting targets promotions based upon consumer consumption of products within that category; usage targeting targets promotions based upon consumer consumption of specific product; brand targeting targets promotions based upon a percentage of purchases of a specific brand; and market targeting targets markets based upon geography. In other embodiments, other types of promotion targeting may include targeting based upon demographic data, income, and the like. In other embodiments, targeting may be combined with any of the above types of offers.

Sub-process 410, in FIG. 3, allows the promoter to specify a promotion display type. In particular, this process allows the promoter select between static or triggered display. In this example, static display is when the promotion is displayed to a consumer in a specific “aisle” or category in the store. Further, triggered display is when the promotion is displayed in response to particular actions of the consumer. For example, when the consumer has placed particular items in her shopping cart, when the consumer shopping patterns have met certain constraints, and the like.

Sub-processes 420 and 430 allow the promoter to preview the specified promotion and confirm the promotion. As will be described below, after confirmation of the promotion is received in data server 150, data server 150 distributes the promotion to the application servers associated with merchant servers specified by the promoter.

Further details regarding promotion creation and definition are described in the above referenced provisional applications.

In the present embodiment, the data collected from promoter servers and application servers are stored within data server 150. In this embodiment, data server typically includes an Oracle 8i database, although in other embodiments, other databases may be used for example, Sybase, Informix, or the like. In this embodiment, there are six logical groups of tables to store the collected data.

One logical group of tables stores data that is “standardized” in the industry. Such tables hold data used by virtually any promoter, retailer, or the like, and include Category information, Product Information, and Market Information. In this embodiment, Category information includes classifications of products or items into distinct groups, such as Dairy, Frozen Foods, Deli, and the like; Product information includes universal product codes (UPC), product names, descriptions, and the like; and Market information includes geographic division of the target territory, such as division by zip code, state, county, or the like.

Another logical group of tables stores data related to a promotion. As disclosed above, various types of information entered by the promoter is stored in such tables. For example, tables include promotion identifiers, promotion formulas, promotion target criteria, promotion delivery criteria, promotion appearance data, and the like.

In the present embodiment, another logical group of tables stores data related to the promoters and/or merchants. As disclosed above, both promoters and merchants can log into data server 150 to view, define, and modify data stored therein. In this embodiment, tables may include promoter name/contact information, retailer name/contact information, and the like.

One logical group of tables stores data related to customers. For example, in such tables, data including customer past purchasing history, demographic information, psychographic information, customer identifier and the like are stored. Additionally, one group of tables store statistical data regarding customer purchasing data, promotion usage data, and the like. Further, one group of tables stores log data related to promotion usage, promotion impressions, and the like.

In other embodiments, other types of tables may be added, or tables may be combined above. It should be understood that re-grouping of data in tables are contemplated in view of the present patent application. Further details regarding database tables are described in the above referenced provisional applications.

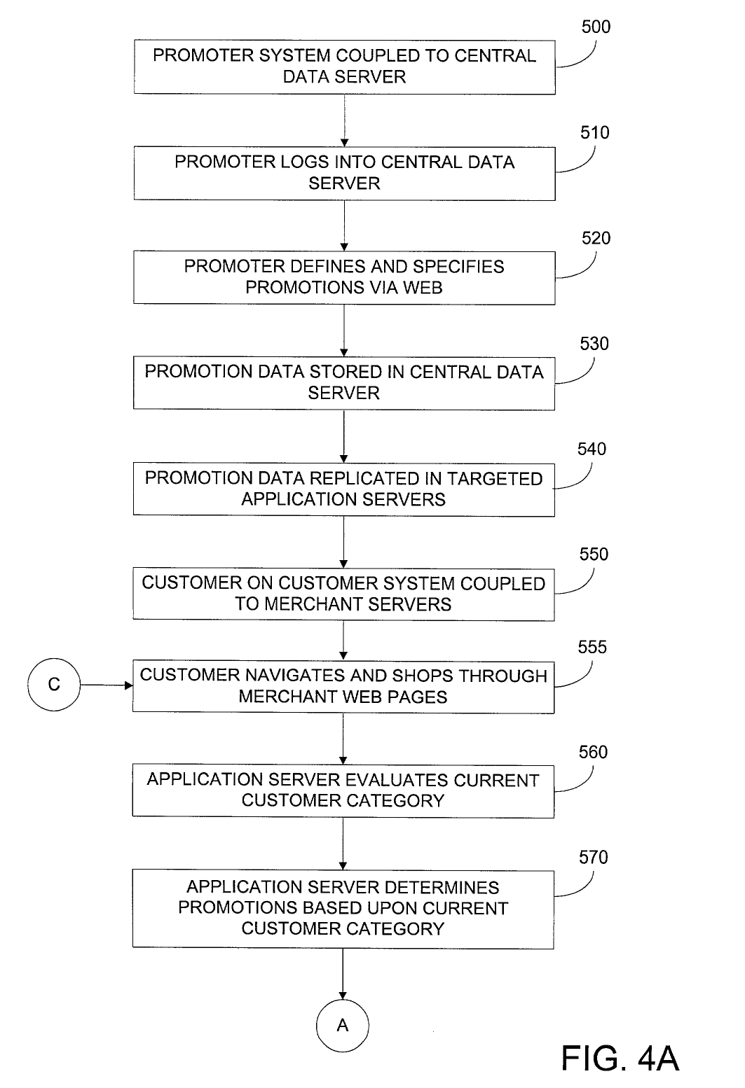

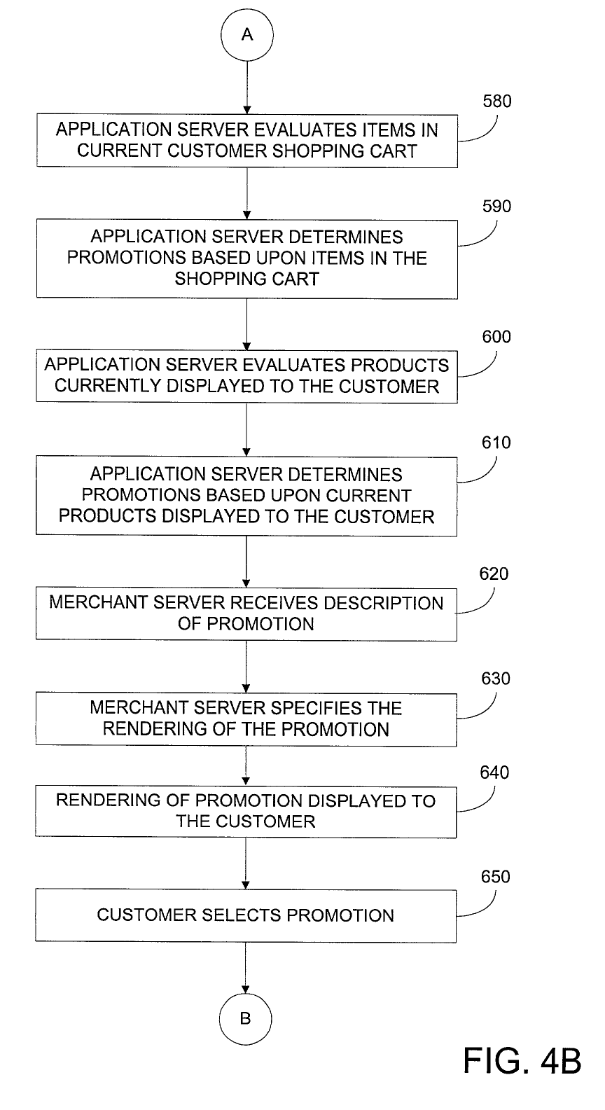

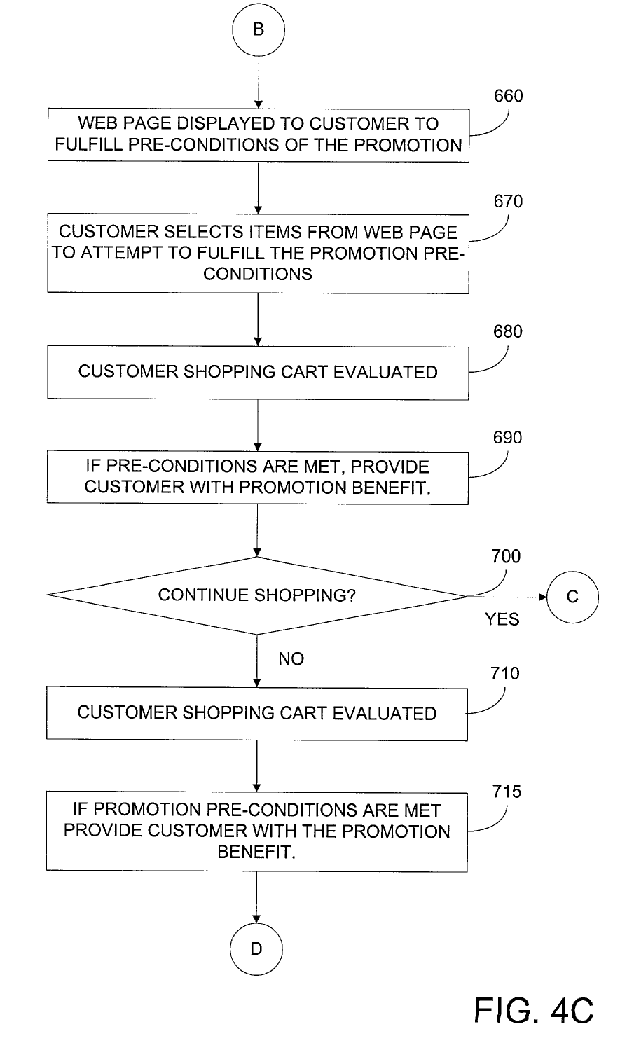

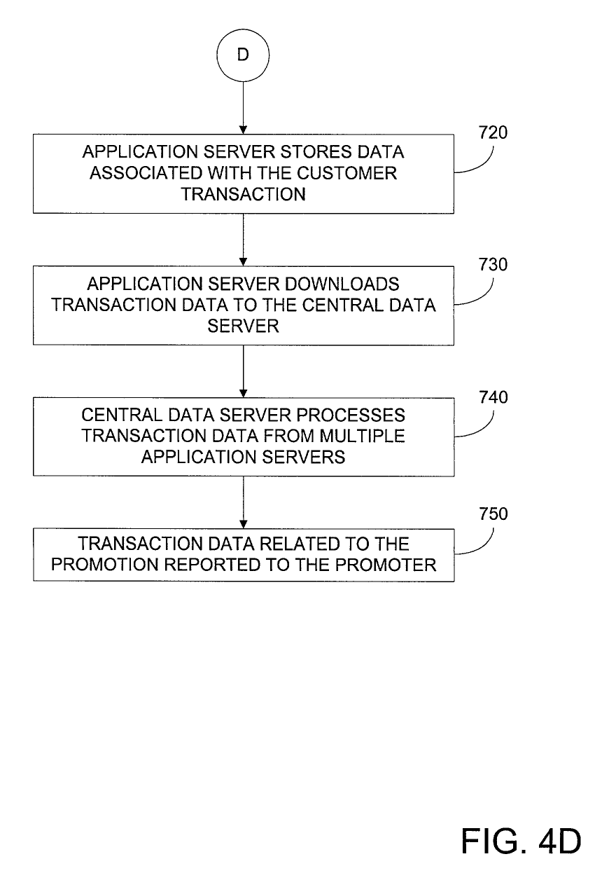

FIGS. 4A-D illustrate a block diagram of a flow chart according to an embodiment of the present invention. In particular, FIGS. 4A-D illustrates the process of defining, using, and reporting usage of a promotion with reference to the elements in FIG. 1.

Initially, a user (promoter) at promoter system 100 (or a merchant system) is coupled to central data server 150, step 500. In one embodiment of the invention, promoter system 100 is coupled to data server 150 via computer network 160. In such embodiments, conventional network protocols may be used such as TCP/IP, IPX, and the like. Other types of networks such as VPN or wireless networks may also be used. In other embodiments, promoter system 100 may be coupled to data server 150 through other direct means such as dial-up lines, wireless connections, dedicated connections and the like. In one embodiment, promoter system 100 uses a web browser to request and retrieve a web page hosted by data server 150.

Once coupled to data server 150, the promoter at promoter system 100 typically logs into their account, step 510. The login process may include the promoter entering their user name and password, PIN, or the like on a Web form.

After successfully logging, in the promoter creates and defines the promotion, step 520. As described above in FIG. 3, various software processes with data server 150 allows the promoter to define the promotion type, delivery method, display type, and the like. The data is typically entered via a series of web form and submissions. In this embodiment, the promotion is stored within data server 150, step 530. Data structures used by data server 150 for storage of the promotion data, and other related data was discussed above.

In the present embodiment, the promotion is then distributed to application servers, such as application server 180, step 540. In one embodiment, promotions are distributed to all application servers. In another embodiment, the promotion may only specify that the promotion is distributed to only application servers coupled to particular merchant servers, such as only PeaPod.com. In alternative embodiments, promotions are not limited to distribution to certain application servers. In this embodiment, the data entered by the promoter is packaged within a data structure, (i.e. a set of promotion data) and downloaded to an application server. Each set of promotion data is typically small, on the order of hundreds of bytes of data.

In the present embodiment, an application server typically receives one or more sets of promotion data, each representing a promotion from data server 150. Data from the set of promotion data is then used to populate data structures within the application server. The merchant server communicates with the application server through use of these data structures, for example, merchant server 140 and application server 180 communicate promotion data, and other data via use of the data structures discussed below.

In the current embodiment, the data structures typically comprise Microsoft COM software objects and object-oriented software programming techniques. In the current embodiment, software objects include: Service objects, “Coupon Objects”, Product objects, Coupons objects, and Products objects. In other embodiments, additional objects may also be used.

In the present example, the merchant server invokes methods within Service objects to query the application server for promotions or to use such promotions. As an example, the merchant server “queries” the application server for promotions or to use the promotions, depending upon data specified by the merchant server. For example, the merchant server may first specify a shopping aisle/category that the consumer is currently browsing, may specify the current items in the consumer's shopping cart, may specify particular products that are presented to the consumer, and the like. In these embodiment, the merchant server may provide such data to the application server by requesting that particular Product objects be instantiated, as described below.

In this example, each Product object instantiated is used to represent an item within a consumer's shopping cart, or the like. A Product object contains a number of Product objects. In this embodiment, Product objects may include an item's UPC code, or the like.

In response to the invocation of methods within the Service objects, and to the instantiation of Product objects, the application server instantiates “Coupon Objects”. In particular, the application server uses the promotional data received from data server 150 and data represented by the Product objects to determine which promotions to display to the user. In this embodiment, the application server instantiates “Coupon Objects” and populates them with the promotions selected for display.

After the “Coupon Objects” have been instantiated by the application server, the merchant server displays the promotion on the display. In this embodiment, the merchant server calls methods of the instantiated Objects to retrieve a description of the promotion. Based upon the description, the merchant server renders a representation of the promotion for display on the customer's system. In the case where a promotion is to be used, a Service object method provides the net savings amount of the promotions used by the customer.

In the present embodiment, the customer and merchant servers are typically given a textual description of the pre-condition and benefit, e.g. “Macroni and Cheese, 8 oz, $0.49.” No direct communication between the application server or customer takes place. If the consumer wishes to receive the benefit specified in the promotion, their actions are effected by the merchant server, and these actions are passed to the application server. The actions must satisfy the pre-condition in the application server before the benefit is provided. In particular, once the application server determines the pre-conditions are met, as discussed above, the application server provides the merchant server the benefit on behalf of the consumer, e.g. a credit of $0.49.

Further details regarding the objects within application server and the interaction of the merchant server and the application server may be found in the above referenced provisional applications.

The promotions typically specify a customer pre-condition and a customer benefit, e.g. buy the product and get a discount; buy two products, get a third one free; buy a product and get a free music CD. These promotions are not considered “coupons” as “coupons” is understood in the industry. More specifically, in the industry, “coupons” are typically defined as detachable certificates, tickets, or the like that entitle the bearer or holder to a benefit. In the present embodiment, the customer and the merchant server are not given any such detachable and/or possessable certificate and cannot hold, bear, or present anything.

By way of contrast, in one electronic couponing systems, a electronic coupon describing a right or benefit is created in a couponing server. The electronic coupon, or token, is then downloaded to a customer's computer system and stored. These coupons or tokens may be in the form of a cookie or the like stored on the customer's computer system. Much later, the customer may enter an electronic store that is independent of the electronic couponing system. Next, the cookie or token stored on the customer's computer system is retrieved and passed back to the electronic store web server. Because the customer's computer had “possession” of the cookie or token in the computer memory, the electronic store web server provides the customer the right or benefit or the bargain described, i.e. the customer is entitled to a 10% discount. This example thus illustrates that the electronic cookie or token incorporates the standard “coupon” model: the customer's computer memory stored the cookie, and possession of the cookie was a condition for receiving the bargain.

Further details regarding the objects within application server and the interaction of the merchant server and the application server may be found in the above referenced provisional applications.

In the present embodiment, a customer on client system 110 is coupled to a merchant server, such as merchant server 140, step 550. In the present embodiment, it is envisioned that merchant system 550 is an on-line store selling goods and/or services. In one embodiment, the on-line store categorizes products in different aisles or categories, e.g. bakery items, snack foods, home loans, mystery books, legal services, and the like. In the present embodiment, client system 110 typically uses a web browser to communicate with merchant server 140 and to display data provided by merchant server 140. Next, the customer typically navigates through the different web pages provided by the merchant server and selects one or more items to put in a shopping cart, or the like, step 555.

In this example, as the customer shops around, the merchant server invokes a Service object within the application server to evaluate the customer's shopping category to determine if there any coupons to display, step 560. In response to the current shopping category, the application server determines whether any promotions are applicable and if so, one or more “Coupon Objects” are instantiated, step 570.

Additionally, the merchant server may also invoke a Service object within the application server to evaluate the items in the customer's shopping cart to determine if there are any coupons to display, step 580. In response to the items in the current shopping cart, the application server determines whether any promotions are applicable for the customer, and if so, one or more “Coupon Objects” are instantiated, step 590.

Further, the merchant server may also invoke a Service object within the application server to evaluate the products currently displayed to the customer to determine if there are any coupons to display, step 600. In response to the products displayed, the application server determines whether any promotions are applicable for the customer, and if so, one or more “Coupon Objects” are also instantiated, step 610.

Next, merchant server 140 queries one or more “Coupon Objects” that have been instantiated for a description of the pre-conditions and benefit, a image of the product, and the like, step 620. In response, merchant server 140 specifies the rendering of the promotion on an HTML page for display on the customer's display, step 630. The visual representation is then displayed on the customer's display, step 640. Embodiments of the visual representation of promotions on a customer display are illustrated in the above referenced provisional applications.

In the present embodiment, based upon the promotion information presented to the customer, the customer may select or click on the visual representation, step 650. In one embodiment, after the customer clicks on the visual representation, the customer is presented with a web page that allows the customer to fulfill the pre-condition, step 660. For example, the promotion may specify that if the customer buys two battery packs, the customer will save $1.50. Then when the customer clicks on the visual representation, the customer is presented with a page listing battery packs offered for sale.

In this embodiment, the consumer may then select or put the items into her shopping cart to attempt to fulfill the pre-conditions of the promotion, step 670. Alternatively, the user may navigate backwards and/or continue shopping without fulfilling the pre-conditions.

As illustrated in FIGS. 4A-D, in this embodiment, after items are placed in a customer shopping cart, it is typically evaluated, step 680. In particular, merchant server 140 causes a reevaluation of the customer's shopping cart, and the application server invokes a method of a Service object to determine the amount of savings provided to the customer. If pre-conditions for coupons are fulfilled by the shopping cart, the appropriate savings are added to the evaluation. The amount of savings is retrieved by merchant server 140 and displayed to the customer, step 690.

In another embodiment, when the customer clicks on the visual representation, the appropriate items may automatically be placed into her shopping cart. For example, the promotion may specify that if the customer buys a blue pen, they will get a red one for free. Thus when the customer clicks on the visual representation of the promotion, the customer's shopping cart is automatically loaded with a blue pen and with a red pen.

In the present embodiment, the consumer may continue shopping or checkout, step 700. When the consumer desires to checkout, merchant server 140 causes application server 180 to use the instances of “Coupon Objects” that were created, step 710. In particular, an evaluate method of a Service object is invoked, and the amount of savings is calculated. The savings is then retrieved by merchant server 140 and displayed to the consumer, step 715

In the present embodiment, when the consumer checks out, a promotion usage condition, application server 180 stores data associated with the transaction, step 720. For example, application server 180 may record the items of the shopping cart, the dollar amount of the items, the number of items, the customer identification and/or customer demographic data provided by merchant server 180, shopping time, the promotions viewed, the promotions used by the customer, and the like. Data server 150 collects data from applications servers running the promotions, and processes such data, step 730.

Periodically, application server 180 contacts data server 150 and downloads the processed transaction data from typically more than one customer, step 740. For example, application server 180 may contact data server 150 every day, once every week, or the like and download data associated with transactions that have occurred since the last time they were in contact. In this embodiment, the data passed back may include the customer's shopping cart specifics, the customer's demographics, promotions accepted, and the like.

Periodically, promoter server 100 contacts data server 150 and retrieves reports describing the promotion's progress and/or success, step 750. In this embodiment, the promoter at promoter server may want to track the progress of their promotions every day, every two days, every week, and the like. As above, in this embodiment, the reports passed back may include shopping cart contents of each customer, the customer's demographics, the dollar amount of the promotion used, and the like.

In the foregoing specification, the invention has been described with reference to specific exemplary embodiments thereof. Many changes or modifications are readily envisioned. For example, as illustrated in FIG. 3, a merchant/retailer may also set up their own promotions in the same way as a promoter. Thus for example, instead of the promotion being specified by promoter 100, the promotion, such as an in store coupon, is specified by a merchant. The merchant may be at merchant server 130 or 140, or even another computer coupled to data server 150 via computer network 160.

Embodiments of the present invention may provide information to the user or consumer more than just promotional information. For example, embodiments may give suggestions such as recipes, related foods, suggested food courses; information in the form of text, video, audio, or the like; URLs of web pages for information; and the like.

Further, embodiments of the present invention may be applied to other areas than for purchase of goods, such as for rental or lease of real property, tangible property, or intangible property, for purchasing or contracting for services, for any financial or barter transaction, for any recommendations such as stock picks or sports betting, for non-profit or volunteer activities, for any application in which a user may benefit by the presentation of additional or related information, and the like.

Further embodiments may be implemented entirely within in-house brick and mortar store servers. Accordingly, the merchant servers, the central data server, and the application server may be owned or operated by one company or related companies. For example, a neighborhood grocer may provide one or more information terminals to shoppers. Based upon the shoppers shopping habits, demographics, or the like, the shopper may be informed that the grocer is offering them a promotion, e.g. buy three, get one free, or the like. Upon check out, if the shopper fulfills the pre-conditions of the promotion, the shopper is automatically given the benefit. Such embodiments can utilize the above described infrastructure to provide such service.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for promoting products with a central server over a computer network comprises:
receiving a specification of a promotion for a product from a first computer,
creating an electronic incentive in response to the specification;
transferring the electronic incentive to an application server across the computer network, the application server coupled to a merchant server;
receiving usage data of the electronic incentive from the application server, the usage data determined in response to a promotion usage condition indicated by the merchant server; and
generating a report in response to the usage data;
wherein data associated with the electronic incentive is transferred from the application server to the merchant server;
wherein the merchant server specifies rendering of the data associated with the electronic incentive; and
wherein the promotion usage condition is indicated in the merchant server when a user coupled thereto fulfills requirements of the electronic incentive.

2. The method of claim 1 wherein the electronic incentive comprises an offer selected from the group: cents off, percent discount, price point, buy X get Y free, solution selling, promotion content.

3. The method of claim 1 wherein the electronic incentive comprises a delivery method selected from the group: non-targeted, targeted category, targeted usage, targeted brand, targeted market.

4. The method of claim 3 wherein the electronic incentive comprises a tracking code.

5. The method of claim 3 wherein the electronic incentive comprises calendar data selected from the group: effective data, expiration date.

6. The method of claim 3 wherein the electronic incentive comprises a network computer address.

7. The method of claim 4 wherein the usage data from the application server comprises data selected from the group: demographic data of the user, a geographic indicator of the user, a number of products purchased by the user, currency value of products purchased by the user, a list of products purchased by the user, the tracking code.

8. A method for a merchant server coupled to a client system comprises:
requesting promotions from an application server coupled to the merchant server;
receiving a description of a promotion from the application server, the description including pre-conditions and a user benefit;
determining an output representation of the promotion in response to the description of the promotion; thereafter
transmitting the output representation of the description to a client system for display to a user;
receiving a selection of at least one item from the client system;
transmitting the selection of the at least one item to the application server;
when the application server determines that the selection of the at least one item fulfills the pre-conditions, receiving an indication that the user is provided with the user benefit from the application server; and thereafter
storing in a log a record that the user is provided with the user benefit.

9. The method of claim 8 wherein the user benefit is selected from the class: cents off, percent discount, price point, buy X get Y free, solution selling, promotion content.

10. The method of claim 8 wherein receiving the description of the promotion comprises receiving the description when the user meets target criteria, the target criteria being selected from the class: targeted user, targeted user demographic, targeted user usage, targeted user brand, targeted user market.

11. The method of claim 8 wherein the pre-conditions are selected from the class: purchase of an item, purchase of a quantity of an item, purchase of at least two different items.

12. The method of claim 8 wherein requesting promotions from the application server comprises:
determining a category of items for display for the client system; and
requesting promotions from the application server in response to the category of items.

13. The method of claim 8 further comprising transmitting a plurality of items to the client system for display;
wherein requesting promotions from the application server comprises requesting promotions from the application server in response to the plurality of items.

14. The method of claim 8 further comprising receiving a selection of a trigger item from the client system; and
wherein requesting promotions from the application server comprises requesting promotions from the application server in response to the trigger item.

15. A method for an application server comprises:
receiving an electronic incentive from a central server, the electronic incentive including a pre-condition and a benefit;
receiving a request from a merchant server for electronic incentives;
providing a description of the electronic incentive to the merchant server in response to the request, the description including a description of the pre-condition and the benefit;
receiving from the merchant server a selection by a user of at least one item;
determining whether the selection of the one item fulfills the pre-condition;
when the selection of the one item fulfills the pre-condition, providing the merchant server with the benefit; and
when the selection of the one item fulfills the pre-condition, recording that the electronic incentive has been used.

16. The method of claim 15 wherein the request from the merchant server also includes a description of a shopping category of a user.

17. The method of claim 15 wherein the request from the merchant server also includes an indicator of items previously selected by the user or currently displayed to the user.

18. The method of claim 15 wherein the pre-condition comprises purchase of the one item.

19. The method of claim 15 wherein the request from the merchant server also includes an identifier of the user.

20. The method of claim 15 further comprising forwarding the recording that the electronic incentive has been used to a centralized server.

21. The method of claim 15 wherein the application server and the merchant server are co-located.
